(19) United States
(12) Patent Application Publication
(10) Pub. No.: US 2026/0301562 A1
(43) Pub. Date: Oct. 1, 2026

(54) MONITORING SYSTEM AND MONITORING METHOD

(71) Applicant: NEC Corporation, Tokyo (JP)

(72) Inventors: Manabu KUSUMOTO, Tokyo (JP); Masatake Takahashi, Tokyo (JP); Yuzo Senda, Tokyo (JP); Daigo Takano, Tokyo (JP)

(73) Assignee: NEC Corporation, Tokyo (JP)

(21) Appl. No.: 19/441,927

(22) Filed: Jan. 7, 2026

(30) Foreign Application Priority Data
Mar. 25, 2025 (JP) 2025-049205

(51) Int. Cl. G08G 1/01; G08G 1/04; G08G 1/052; G08G 1/056

(52) U.S. Cl. CPC G08G 1/0116; G08G 1/04; G08G 1/052; G08G 1/056

(57) ABSTRACT

A monitoring system according to the present disclosure includes a protrusion group or a groove group arranged in a specific arrangement pattern on a road, at least one memory that stores instructions, and at least one processor configured to execute the instructions to, detect vibration generated on the road, extract a vibration waveform of the vibration, and determine a number of vehicles traveling on the road by correlating the vibration waveform with the arrangement pattern.

### INCORPORATION BY REFERENCE

This application is based upon and claims the benefit of priority from Japanese patent application No. 2025-049205, filed on Mar. 25, 2025, the disclosure of which is incorporated herein in its entirety by reference.

### TECHNICAL FIELD

The present disclosure relates to a monitoring system and a monitoring method.

### BACKGROUND ART

In a musical road, a melody is generated as a vehicle travels. For example, a musical road is formed by making a groove in a road.

Recently, there has been proposed a technique for monitoring a traffic flow using a traveling sound generated by a vehicle traveling on a musical road.

For example, according to the technique disclosed in JP 2016-170538 A, a musical road is provided in a section where traveling is dangerous, and a traveling sound generated by the vehicle traveling on the musical road is stored in advance as reference data. Then, based on the traveling sound collected by the vehicle and the reference data, it is determined whether the vehicle is traveling in a dangerous section.

### SUMMARY

However, in general, a deep groove is dug in a musical road in order to generate a melody. Therefore, as in the technique disclosed in JP 2016-170538 A, in a case where a traffic flow is monitored using a musical road, there are problems that a large noise is generated as a vehicle travels on the musical road and that ride comfort of a driver of the vehicle is deteriorated.

Therefore, in view of the above-described problems, an example object of the present disclosure is to provide a monitoring system and a monitoring method capable of monitoring a traffic flow without generating large noise or deteriorating ride comfort of a driver.

A monitoring system according to an example aspect includes
a protrusion group or a groove group arranged in a specific arrangement pattern on a road,
at least one memory that stores instructions, and
at least one processor configured to execute the instructions to:
detect vibration generated on the road;
extract a vibration waveform of the vibration; and
determine a number of vehicles traveling on the road by correlating the vibration waveform with the arrangement pattern.

A monitoring method according to an example aspect is a monitoring method executed by a monitoring system, the method including
detecting vibration generated on a road on which a protrusion group or a groove group is arranged in a specific arrangement pattern,
extracting a vibration waveform of the vibration, and
determining a number of vehicles that have traveled on the road by correlating the vibration waveform with the arrangement pattern.

According to the above-described example aspect, it is possible to provide the monitoring system and the monitoring method capable of monitoring the traffic flow without generating large noise or deteriorating the ride comfort of the driver.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a diagram for explaining an outline of the present disclosure;

FIG. 2 is a diagram illustrating an example of a pseudo random pattern according to the present disclosure;

FIG. 3 is a block diagram illustrating a block configuration example of a monitoring system according to the present disclosure;

FIG. 4 is a diagram for explaining an operation example of a determination unit according to the present disclosure;

FIG. 5 is a flowchart for explaining an example of an operation flow of a monitoring system according to the present disclosure;

FIG. 6 is a diagram for explaining an operation example of the determination unit according to the present disclosure;

FIG. 7 is a diagram for explaining an operation example of the determination unit according to the present disclosure; and

FIG. 8 is a block diagram illustrating a hardware configuration example of a computer that implements the monitoring device according to the present disclosure.

### EXAMPLE EMBODIMENT

Hereinafter, example embodiments of the present disclosure will be described with reference to the diagrams. The following description and drawings are omitted and simplified as appropriate for clarity of description. In the following drawings, the same elements will be denoted by the same reference signs, and redundant description will be omitted as necessary.

### First Example Embodiment

First, an outline of the present disclosure will be described.

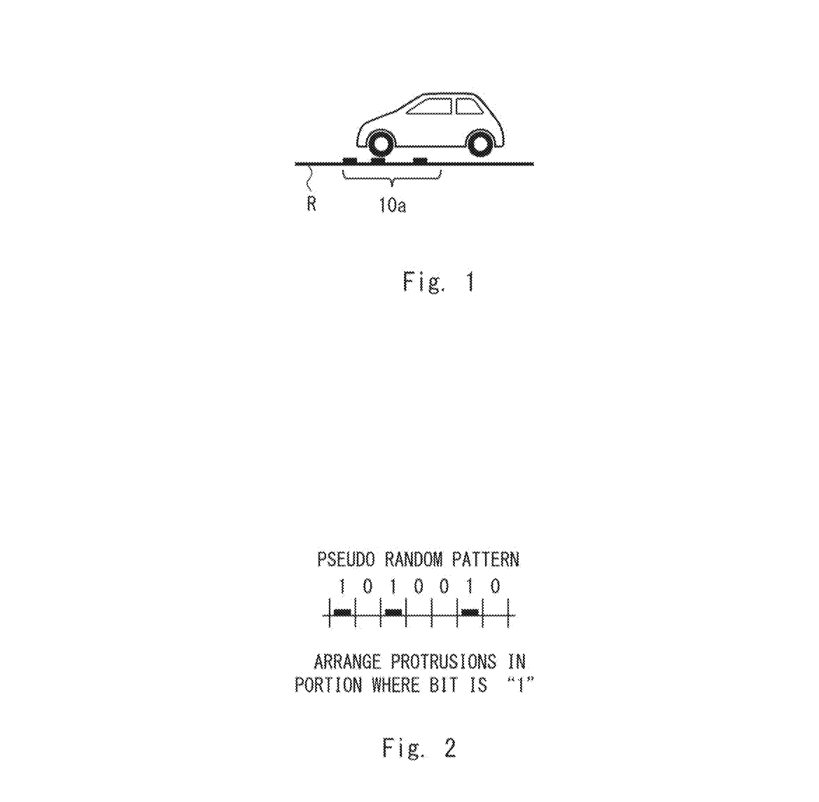

FIG. 1 is a diagram for explaining the outline of the present disclosure.

As illustrated in FIG. 1, in the present disclosure, a protrusion group or a groove group (protrusion group 10a is illustrated in FIG. 1) is arranged on a road R in a specific arrangement pattern, and as a vehicle travels on the protrusion group or the groove group, vibration is generated.

Therefore, it is considered that a vibration pattern relevant to the arrangement pattern of the protrusion group or the groove group appears in the vibration waveform of the vibration generated as the vehicle travels on the protrusion group or the groove group of the road R.

Therefore, in the present disclosure, the traffic flow is monitored by correlating the vibration waveform of the vibration generated on the road R with the arrangement pattern of the protrusion group or the groove group.

For example, in a case where the groove group is arranged on the road R, the groove group may be formed by digging a plurality of grooves on the road R.

For example, in a case where the protrusion group is disposed on the road R, a plurality of protrusions may be formed on the road R with paint or the like, or a sheet on which a plurality of protrusions is formed may be installed on the road R.

For example, the arrangement pattern of the protrusion group or the groove group may be a pattern according to a pseudo random pattern. As the pseudo random pattern, a pattern of a Gold sequence may be used.

FIG. 2 is a diagram illustrating an example of a pseudo random pattern according to the present disclosure. FIG. 2 is an example of a pseudo random pattern serving as an arrangement pattern of the protrusion group 10a in FIG. 1.

For example, the arrangement pattern of the protrusion group 10a is a pattern in which the protrusions are arranged at the portions of “1” in the bit string of the pseudo random pattern illustrated in FIG. 2. Similarly, also in the case of the groove group, a pattern in which the grooves are arranged in the portions of “1” is the arrangement pattern of the groove group.

For example, on the road R, the presence or absence of the protrusion or the groove may be determined at intervals of 1.67 [m] according to the pseudo random pattern. In this case, as the vehicle travels on the road R at a traveling speed of 60 [k/h], vibration having a frequency of about 10 [Hz] is generated. The above interval on the road R may be determined according to the frequency at which vibration occurs and the speed of the vehicle on the road R (for example, a speed limit, an average traveling speed, and the like).

The arrangement pattern of the protrusion group or the groove group is not limited to the pattern according to the pseudo random pattern, and may be any pattern in which vibration is generated as the vehicle travels on the protrusion group or the groove group. For example, the arrangement pattern of the protrusion group or the groove group may be a chirp wave pattern or a pattern obtained by performing spread spectrum on any bit string. The spread spectrum method may be a direct sequence spread spectrum (DSSS) method, an orthogonal frequency division multiplexing (OFDM) method, or the like.

Subsequently, a configuration of a monitoring system 1 according to the present disclosure will be described.

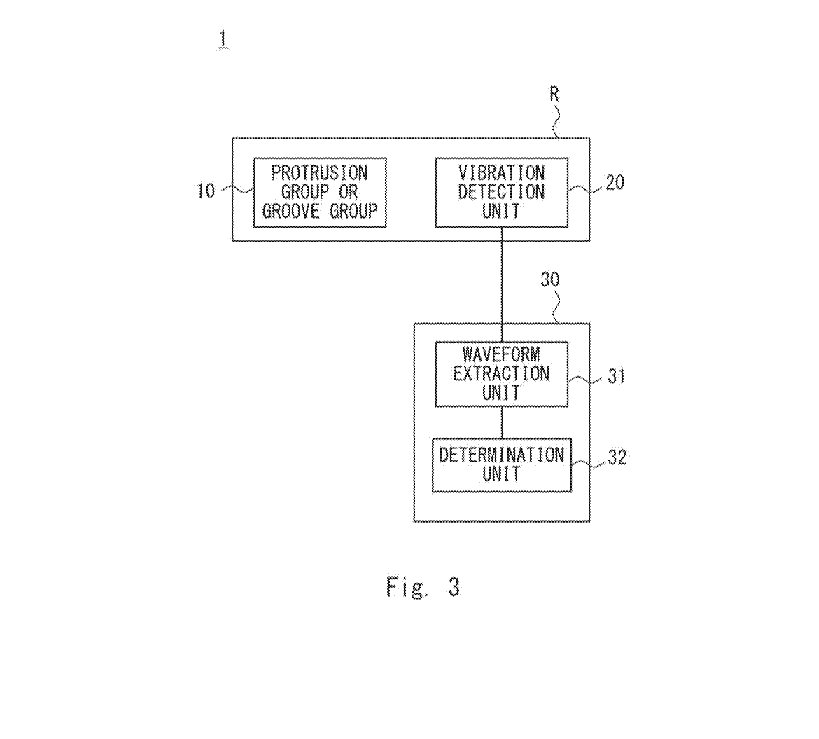

FIG. 3 is a block diagram illustrating a block configuration example of a monitoring system 1 according to the present disclosure.

As illustrated in FIG. 3, the monitoring system 1 includes a protrusion group or a groove group 10, a vibration detection unit 20, and a monitoring device 30. The monitoring device 30 is connected to the vibration detection unit 20 in a wired or wireless manner, and includes a waveform extraction unit 31 and a determination unit 32.

As described above, the protrusion group or the groove group 10 is arranged in a specific arrangement pattern on the road R.

The vibration detection unit 20 is disposed at any position on the road R and detects vibration generated on the road R.

For example, the vibration detection unit 20 may be a distributed fiber optic sensing (DFOS) device that is connected to an optical fiber embedded in the road R and detects vibration generated on the road R by optical fiber sensing using the optical fiber.

However, the vibration detection unit 20 is not limited to the DFOS device, and may be any means capable of detecting vibration generated on the road R. For example, the vibration detection unit 20 may be a vibration sensor or a vibratory meter that detects vibration in a non-contact manner using a laser. The vibration detection unit 20 may be a camera, a light detection and ranging (LiDAR), a high-speed camera, or the like.

The waveform extraction unit 31 extracts a vibration waveform of the vibration detected by the vibration detection unit 20.

The determination unit 32 determines the number of vehicles traveling on the road R by correlating the vibration waveform extracted by the waveform extraction unit 31 with the arrangement pattern of the protrusion group or the groove group 10.

Next, an operation of the determination unit 32 according to the present disclosure will be described with a specific example.

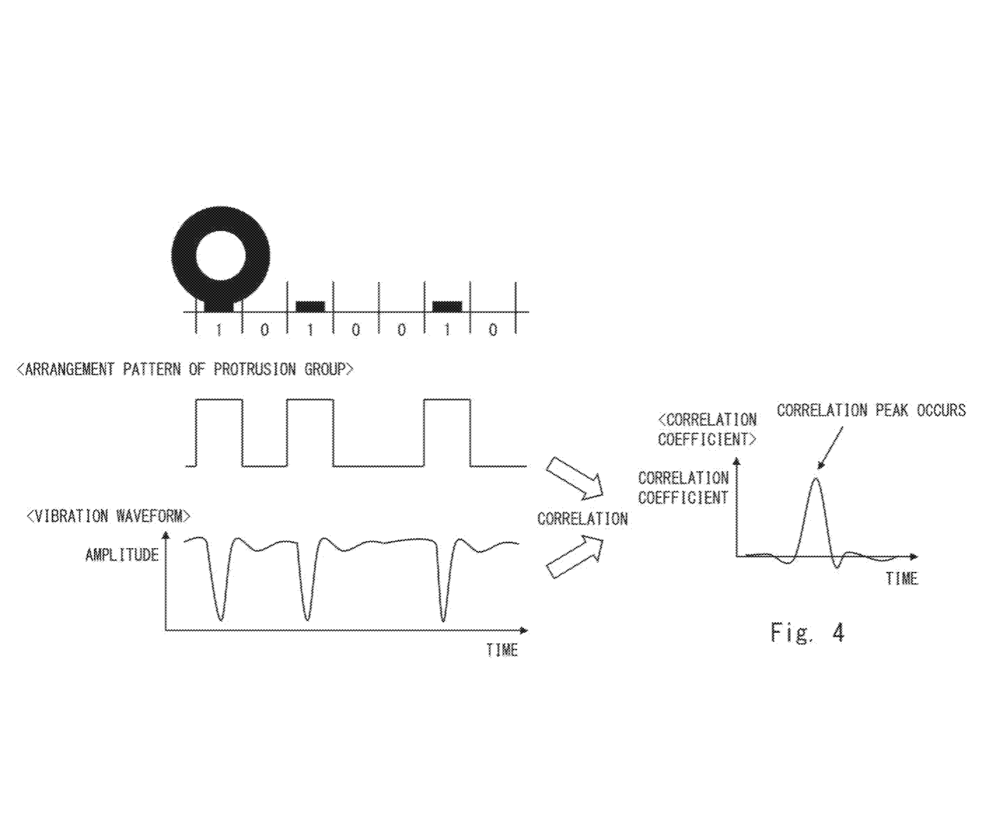

FIG. 4 is a diagram for explaining an operation example of the determination unit 32 according to the present disclosure. FIG. 4 illustrates an example in which the protrusion group 10a similar to those in FIG. 1 is arranged as the protrusion group or the groove group 10 on the road R.

As illustrated in FIG. 4, as the vehicle travels on the protrusions constituting the protrusion group 10a of the road R, the ground is pushed by the protrusions, so that large vibration is generated. The vibration waveform in FIG. 4 indicates a vibration waveform of vibration generated as the vehicle travels on the protrusion group 10a of the road R.

The determination unit 32 correlates the vibration waveform with the arrangement pattern of the protrusion group 10a and calculates a correlation coefficient.

Here, the vibration waveform in FIG. 4 includes a vibration pattern relevant to the arrangement pattern of the protrusion group 10a. Therefore, once the vibration waveform in FIG. 4 and the arrangement pattern of the protrusion group 10a are correlated with each other, a correlation peak occurs at a timing at which the vibration pattern included in the vibration waveform and the arrangement pattern of the protrusion group 10a substantially coincide with each other. Therefore, one correlation peak occurs in the correlation coefficient of FIG. 4.

Therefore, in a case where a correlation peak occurs in the correlation coefficient, the determination unit 32 determines that the vehicle has traveled on the protrusion group 10a of the road R. The determination unit 32 determines the number of vehicles traveling on the protrusion group 10a of the road R, that is, the number of vehicles traveling on the road R, from the number of correlation peaks generated in the correlation coefficient.

Subsequently, an operation flow of the monitoring system 1 according to the present disclosure will be described.

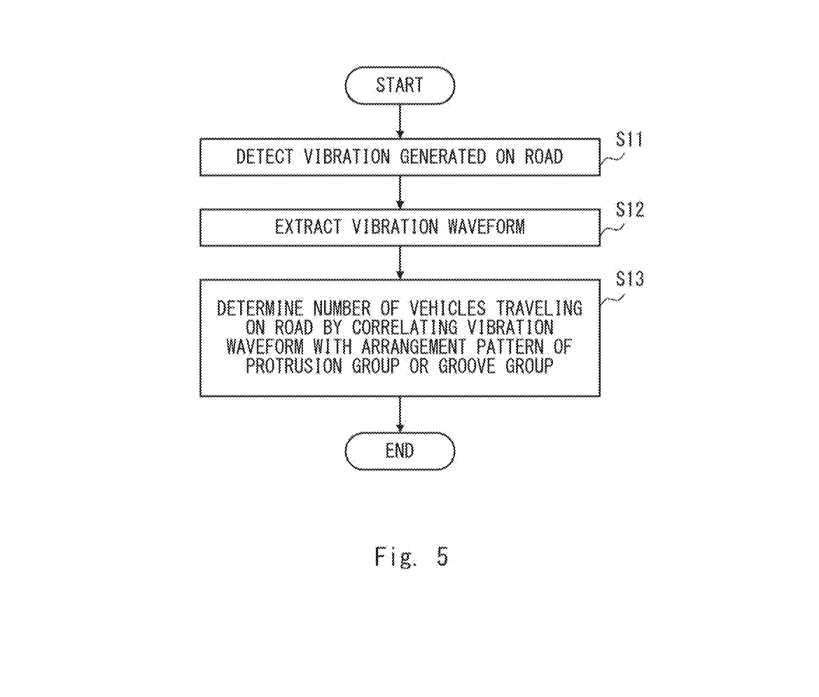

FIG. 5 is a flowchart for explaining an example of an operation flow of a monitoring system 1 according to the present disclosure.

As illustrated in FIG. 5, the vibration detection unit 20 detects vibration generated on the road R (step S11).

Next, the waveform extraction unit 31 extracts a vibration waveform of the vibration detected by the vibration detection unit 20 (step S12).

Thereafter, the determination unit 32 determines the number of vehicles that have traveled on the road R by correlating the vibration waveform extracted by the waveform extraction unit 31 with the arrangement pattern of the protrusion group or the groove group 10 (step S13).

As described above, according to the first example embodiment, the protrusion group or the groove group 10 is arranged on the road R in a specific arrangement pattern. The vibration detection unit 20 detects the vibration generated on the road R. The waveform extraction unit 31 extracts a vibration waveform of the vibration detected by the vibration detection unit 20. The determination unit 32 determines the number of vehicles traveling on the road R by correlating the vibration waveform extracted by the waveform extraction unit 31 with the arrangement pattern of the protrusion group or the groove group 10.

As described above, according to the first example embodiment, the number of vehicles is determined using the vibration as the vehicle travels on the protrusion group or the groove group 10 of the road R. Therefore, the protrusion group or the groove group 10 only needs to generate constant vibration as the vehicle travels, and it is not necessary to form deep grooves or to form high protrusions such as musical road. As a result, it is possible to monitor the traffic flow (here, the number of vehicles that have traveled on the road R) without generating a large noise or deteriorating the ride comfort of the driver.

### Other Example Embodiments

In the first example embodiment described above, the monitoring system 1 monitors the number of vehicles traveling on the road R, but the present disclosure is not limited thereto.

For example, the monitoring system 1 may monitor a lane of the road R on which the vehicle has traveled.

In this case, the protrusion group or the groove group 10 is arranged in a different arrangement pattern for each of the plurality of lanes of the road R. Then, the determination unit 32 determines the lane of the road R on which the vehicle has traveled by correlating the vibration waveform with the arrangement pattern of each of the plurality of lanes of the road R.

The monitoring system 1 may monitor the traveling speed of the vehicle that has traveled on the road R.

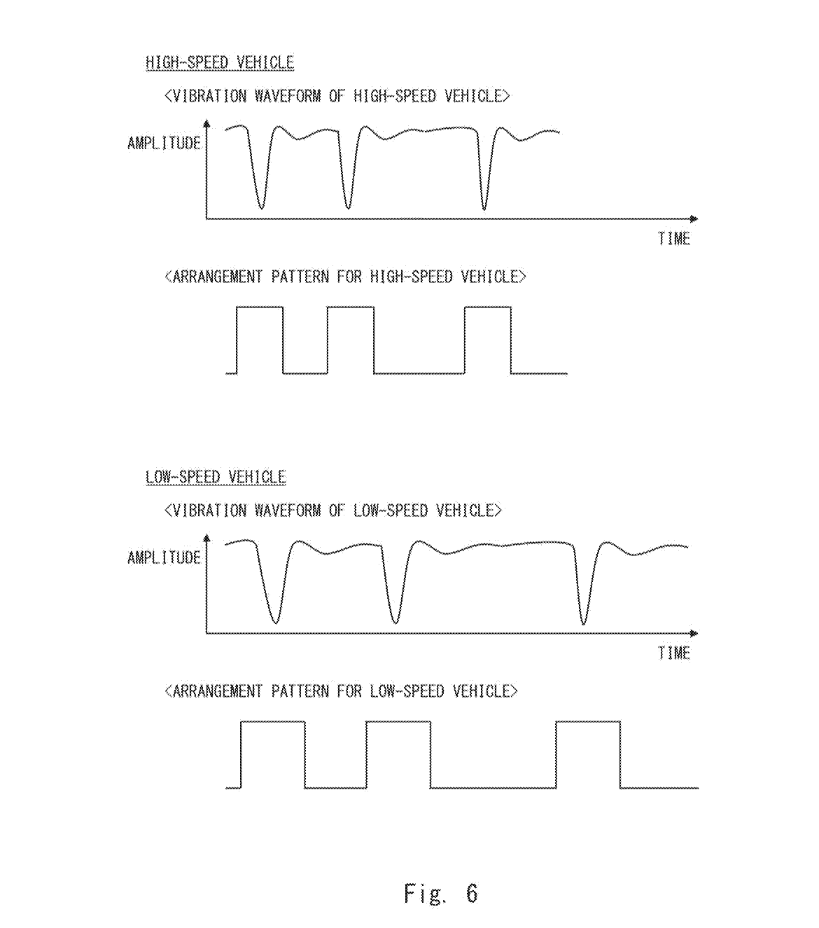

FIG. 6 illustrates vibration waveforms as a high-speed vehicle and a low-speed vehicle travel on the protrusion group 10a arranged in the arrangement pattern of FIG. 4 on the road R.

As illustrated in FIG. 6, if the traveling speed of the vehicle is different, the vibration waveform as the vehicle travels on the protrusion group 10a is also different.

Therefore, the determination unit 32 derives in advance the arrangement pattern deformed according to the traveling speed for each of the plurality of traveling speeds of the vehicle traveling on the road R. Then, the determination unit 32 determines the traveling speed of the vehicle traveling on the road R by correlating the vibration waveform with the deformed arrangement pattern of each of the plurality of traveling speeds.

FIG. 6 illustrates an example in which the traveling speed of the vehicle is classified into two types of high speed and low speed, but the present disclosure is not limited thereto. The traveling speed of the vehicle may be further finely classified into three or more.

The monitoring system 1 may monitor the position of the road R on which the vehicle has traveled.

In this case, the protrusion group or the groove group 10 is arranged in a different arrangement pattern for each of the plurality of positions of the road R. Then, the determination unit 32 determines the position of the road R on which the vehicle has traveled by correlating the vibration waveform with the arrangement pattern of each of the plurality of positions of the road R.

The monitoring system 1 may monitor the traveling direction of the vehicle that has traveled on the road R.

In a case where the vehicle travels in the reverse direction on the protrusion group or the groove group 10 arranged in a specific arrangement pattern on the road R, it is considered that a reverse pattern of the arrangement pattern appears in the vibration waveform at that time.

Therefore, the determination unit 32 derives a reverse pattern of the arrangement pattern of the protrusion group or the groove group 10 in advance. Then, the determination unit 32 determines the traveling direction of the vehicle traveling on the road R by correlating the vibration waveform with the arrangement pattern and correlating the vibration waveform with the reverse pattern of the arrangement pattern. As a result, it is possible to monitor that the vehicle is traveling in the wrong direction on the road R.

The monitoring system 1 may monitor the number of axles of the vehicle that has traveled on the road R.

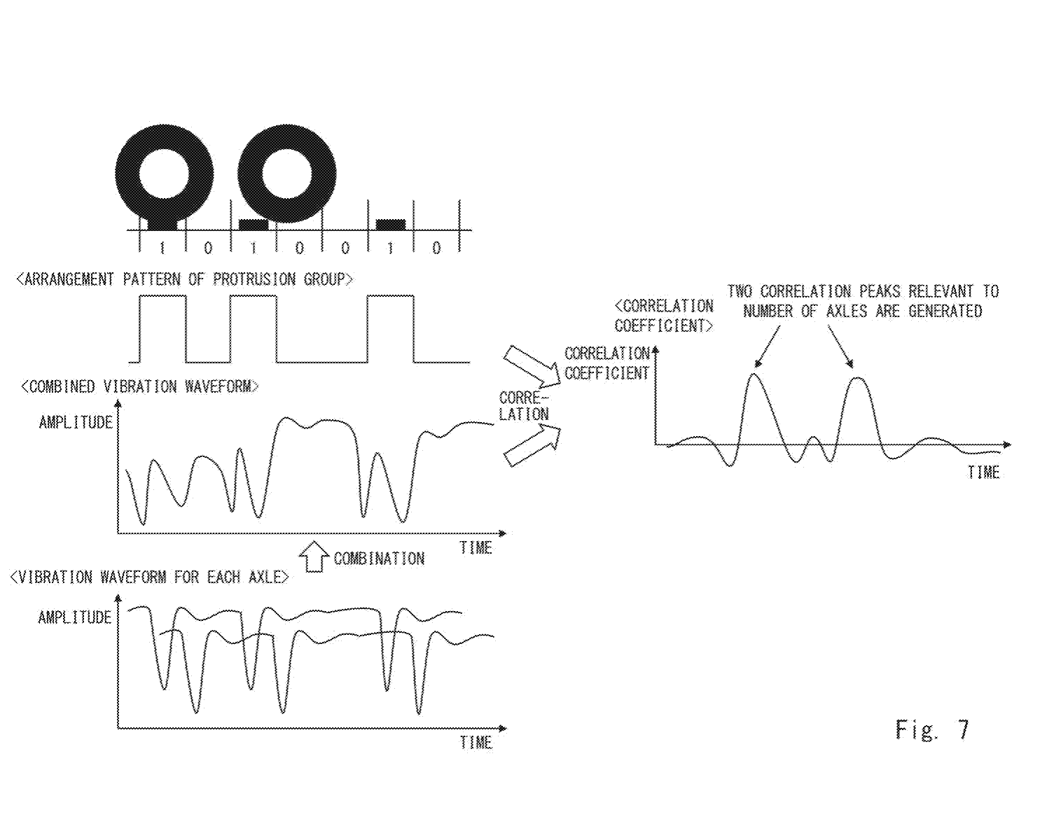

FIG. 7 illustrates a vibration waveform as a vehicle having two axles travels on the protrusion group 10a arranged in the arrangement pattern of FIG. 4 on the road R.

As illustrated in FIG. 7, as a vehicle having two axles travels on the protrusion group 10a, vibration is generated for each of the two axles, and the vibration waveform of the vibration includes a vibration pattern relevant to the arrangement pattern of the protrusion group 10a. However, the vibration waveform extracted by the waveform extraction unit 31 at that time is a vibration waveform obtained by combining the vibration waveforms of the two axles. Once the combined vibration waveform and the arrangement pattern of the protrusion group 10a are correlated with each other, a correlation peak occurs at a timing at which the vibration pattern of each of the two axles and the arrangement pattern of the protrusion group 10a substantially coincide with each other. Therefore, two correlation peaks occur in the correlation coefficient of FIG. 7.

Therefore, the determination unit 32 determines the number of axles of the vehicle traveling on the road R by correlating the vibration waveform with the arrangement pattern.

In a case where a plurality of correlation peaks occur in the correlation coefficient, the determination unit 32 needs to distinguish whether the subsequent correlation peak is a correlation peak of another vehicle or a correlation peak of another axle of the same vehicle. In this case, for example, if the time interval between the correlation peaks is equal to or greater than a threshold, the determination unit 32 may determine that the correlation peak is a correlation peak of another vehicle, and if the time interval is less than the threshold, the determination unit may determine that the correlation peak is a correlation peak of another axle of the same vehicle.

### Hardware Configuration of Monitoring Device according to Present Disclosure

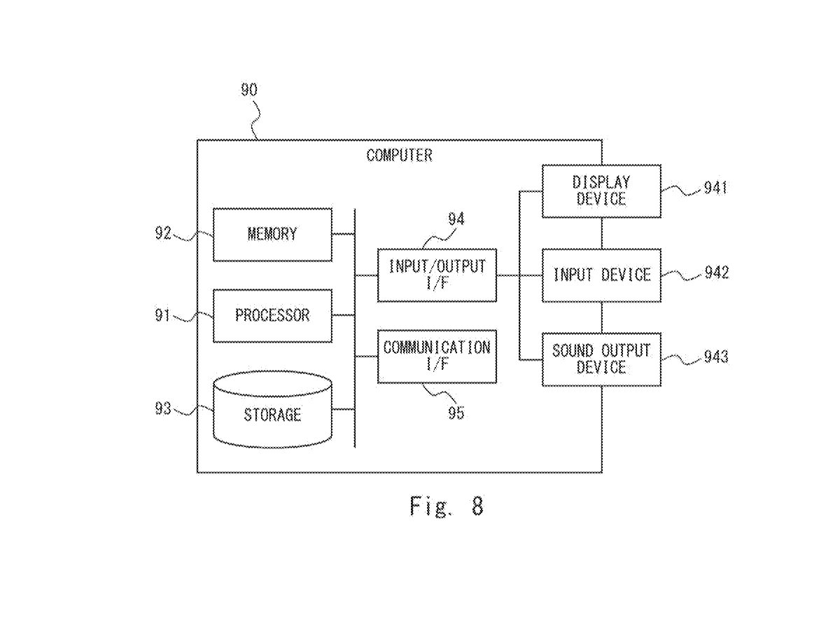

FIG. 8 is a block diagram illustrating a hardware configuration example of a computer 90 that implements the monitoring device 30 according to the present disclosure.

As illustrated in FIG. 8, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is, for example, an arithmetic processing device such as a central processing unit (CPU) or a graphics processing unit (GPU). The memory 92 is, for example, a memory such as a random access memory (RAM) or a read only memory (ROM). The storage 93 is, for example, a storage device such as a hard disk drive (HDD), a solid state drive (SSD), or a memory card. The storage 93 may be a memory such as the RAM or the ROM.

A program is stored in the storage 93. This program includes instructions (or software codes) for causing the computer 90 to perform one or more functions in the monitoring device 30 according to the present disclosure in a case where the program is read by the computer. The components of the monitoring device 30 according to the present disclosure described above may be implemented by the processor 91 reading and executing a program stored in the storage 93. The storage function in the monitoring device30 according to the present disclosure may be implemented by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display device 941, an input device 942, a sound output device 943, and the like. The display device 941 is a device that displays a screen associated with drawing data processed by the processor 91, such as a liquid crystal display (LCD), a cathode ray tube (CRT) display, or a monitor. The input device 942 is a device that receives operator’s operation input, and is, for example, a keyboard, a mouse, a touch sensor, or the like. The display device 941 and the input device 942 may be integrated and implemented as a touch panel. The sound output device 943 is an apparatus that acoustically outputs a sound that is relevant to acoustic data processed by the processor 91, such as a speaker.

The communication interface 95 transmits or receives data to and from an external apparatus. For example, the communication interface 95 communicates with an external apparatus via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

A monitoring system including:
a protrusion group or a groove group arranged in a specific arrangement pattern on a road;
at least one memory that stores instructions; and
at least one processor configured to execute the instructions to: detect vibration generated on the road;
extract a vibration waveform of the vibration; and
determine a number of vehicles traveling on the road by correlating the vibration waveform with the arrangement pattern.

### Supplementary Note 2

The monitoring system according to Supplementary Note 1, in which
the protrusion group or the groove group is arranged in the arrangement pattern different for each of a plurality of lanes of the road, and
the at least one processor is configured to execute the instructions to determine a lane of the road on which a vehicle has traveled by correlating the vibration waveform with the arrangement pattern of each of a plurality of lanes of the road.

### Supplementary Note 3

The monitoring system according to Supplementary Note 1, in which
the at least one processor is configured to execute the instructions to: derive in advance, for each of a plurality of traveling speeds of a vehicle traveling on the road, the arrangement pattern deformed in accordance with the traveling speed; and
determine a traveling speed of a vehicle traveling on the road by correlating the vibration waveform with the deformed arrangement pattern of each of a plurality of traveling speeds of the vehicle traveling on the road.

### Supplementary Note 4

The monitoring system according to Supplementary Note 1, in which
the protrusion group or the groove group is arranged in the arrangement pattern different for each of a plurality of positions of the road, and
the at least one processor is configured to execute the instructions to determine a position of the road on which a vehicle has traveled by correlating the vibration waveform with the arrangement pattern of each of a plurality of positions of the road.

### Supplementary Note 5

The monitoring system according to Supplementary Note 1, in which
the at least one processor is configured to execute the instructions to:
derive in advance a reverse pattern of the arrangement pattern; and
determine a traveling direction of a vehicle traveling on the road by correlating the vibration waveform with the arrangement pattern and by correlating the vibration waveform with a reverse pattern of the arrangement pattern.

### Supplementary Note 6

The monitoring system according to Supplementary Note 1, in which the at least one processor is configured to execute the instructions to determine a number of axles of a vehicle that has traveled on the road by correlating the vibration waveform with the arrangement pattern.

### Supplementary Note 7

The monitoring system according to Supplementary Note 1, in which the arrangement pattern is a pseudo random pattern.

### Supplementary Note 8

The monitoring system according to Supplementary Note 1, in which the at least one processor is configured to execute the instructions to detect the vibration by optical fiber sensing using an optical fiber embedded in the road.

### Supplementary Note 9

A monitoring method executed by a monitoring system, including:
detecting vibration generated on a road on which a protrusion group or a groove group is arranged in a specific arrangement pattern;
extracting a vibration waveform of the vibration; and
determining a number of vehicles that have traveled on the road by correlating the vibration waveform with the arrangement pattern.

Note that, some or all of elements (e.g., structures and functions) specified in Supplementary Notes 2 to 8 dependent on Supplementary Note 1 may also be dependent on Supplementary Note 9 in dependency similar to that of

Supplementary Notes 2 to 8 dependent on Supplementary Note 1. Some or all of elements specified in any of Supplementary Notes may be applied to various types of hardware, software, and recording means for recording software, systems, and methods.

What is claimed is:

1. A monitoring system comprising:
a protrusion group or a groove group arranged in a specific arrangement pattern on a road;
at least one memory that stores instructions; and
at least one processor configured to execute the instructions to:
detect vibration generated on the road;
extract a vibration waveform of the vibration; and
determine a number of vehicles traveling on the road by correlating the vibration waveform with the arrangement pattern.

2. The monitoring system according to claim 1, wherein
the protrusion group or the groove group is arranged in the arrangement pattern different for each of a plurality of lanes of the road, and
the at least one processor is configured to execute the instructions to determine a lane of the road on which a vehicle has traveled by correlating the vibration waveform with the arrangement pattern of each of a plurality of lanes of the road.

3. The monitoring system according to claim 1,
wherein the at least one processor is configured to execute the instructions to:
derive in advance, for each of a plurality of traveling speeds of a vehicle traveling on the road, the arrangement pattern deformed in accordance with the traveling speed; and
determine a traveling speed of a vehicle traveling on the road by correlating the vibration waveform with the deformed arrangement pattern of each of a plurality of traveling speeds of the vehicle traveling on the road.

4. The monitoring system according to claim 1, wherein
the protrusion group or the groove group is arranged in the arrangement pattern different for each of a plurality of positions of the road, and
the at least one processor is configured to execute the instructions to determine a position of the road on which a vehicle has traveled by correlating
the vibration waveform with the arrangement pattern of each of a plurality of positions of the road.

5. The monitoring system according to claim 1,
wherein the at least one processor is configured to execute the instructions to:
derive in advance a reverse pattern of the arrangement pattern; and
determine a traveling direction of a vehicle traveling on the road by correlating the vibration waveform with the arrangement pattern and by correlating the vibration waveform with a reverse pattern of the arrangement pattern.

6. The monitoring system according to claim 1, wherein the at least one processor is configured to execute the instructions to determine a number of axles of a vehicle that has traveled on the road by correlating the vibration waveform with the arrangement pattern.

7. The monitoring system according to claim 1, wherein the arrangement pattern is a pseudo random pattern.

8. The monitoring system according to claim 1, wherein the at least one processor is configured to execute the instructions to detect the vibration by optical fiber sensing using an optical fiber embedded in the road.

9. A monitoring method executed by a monitoring system, comprising:
detecting vibration generated on a road on which a protrusion group or a groove group is arranged in a specific arrangement pattern;
extracting a vibration waveform of the vibration; and
determining a number of vehicles that have traveled on the road by correlating the vibration waveform with the arrangement pattern.
